(19) United States
(12) Patent Application Publication
(10) Pub. No.: US 2021/0286734 A1
(43) Pub. Date: Sep. 16, 2021

(54) PERSISTENT READ CACHE IN A SCALE OUT STORAGE SYSTEM

(71) Applicant: ORCA DATA TECHNOLOGY (XI'AN) CO., LTD, Xianyang (CN)

(72) Inventors: ARTHUR JAMES BEAVERSON, BOXBOROUGH, MA (US); BANG CHANG, CARY, NC (US); Ken Chiquoine, Littleton, MA (US)

(21) Appl. No.: 17/198,611

(22) Filed: Mar. 11, 2021

Related U.S. Application Data
(60) Provisional application No. 62/988,103, filed on Mar. 11, 2020.

(51) Int. Cl. G06F 12/1018; G06F 12/02

(52) U.S. Cl. CPC G06F 12/1018; G06F 2212/1044; G06F 12/023

(57) ABSTRACT

Methods, apparatuses, systems, and media for implementing a persistent read cache in a scale out storage system are disclosed to reduce access latency and achieve higher performance. Both the cached data blocks and distributed data placements are referenced by their unique content identifiers and are deduplicated. The persistent read cache spans across node reboots and is inherently coherent across all storage nodes without a distributed lock manager. The cached data blocks share the same storage pool as distributed data placements without costing storage capacity. A cached data block can become a distributed data placement or vice versa without moving the physical data block. Methods are also disclosed to reduce time to performance for logical device mobility.

### CROSS-REFERENCE TO RELATED APPLICATION

This application claims priority to U.S. Provisional Patent Application No. 62/988,103, filed Mar. 11, 2020, the entire contents of which are herein incorporated by reference in their entirety.

### TECHNICAL FIELD

The present disclosure relates generally to storage systems, and, more specifically, to persistent read cache in a scale out storage system.

### BACKGROUND

A scale out storage system typically includes a plurality of nodes connected by a network. Each of the nodes may be equipped with a processor, a memory, and a number of storage devices. The storage devices may include hard disk drives (HDDs), solid-state devices (SSDs), or a combination of both (Hybrid). The storage devices may be configured under a RAID (Redundant Array of Inexpensive Disks) hardware or software for data redundancy and load balancing. The storage devices may be locally attached to each node or shared among multiple nodes. The processor may be dedicated to running storage software or shared between storage software and user applications. Storage software, such as a logical volume manager and a file system, provides storage virtualization and data services such as snapshots and clones.

Storage virtualization may decouple the logical devices addressed by user applications from the physical data placement on the storage devices. Storage virtualization allows the processor to optimize physical data placement based on the characteristics of the storage devices and provide capacity reduction such as data deduplication and compression. User applications address a logical device by its Logical Unit Number (LUN). A logical data block associated with a logical device is identified by a logical block number (LBN). Thus, a complete logical address for a logical data block comprises the LUN of the logical device and the LBN of the logical block. To support storage virtualization, the processor translates each user I/O request addressed to a LUN/LBN to a set of I/O requests addressed to storage device IDs and physical block numbers (PBNs). That is, the storage software translates the logical addresses of the logical data blocks into corresponding physical addresses for the physical data blocks stored on the data storage devices. In some storage software implementations, in order to perform this translation, the processor maintains forward map metadata that maps each data block's LBN to its PBN.

Logical device availability may refer to making a logical device accessible on node B in the event that its original access point on node A becomes unavailable. Logical device mobility may refer to moving the access point of a logical device from node A to node B for load balancing or during an upgrade. Both logical device availability and mobility can be measured by “time to access” and “time to performance.” “Time to access” may be defined as the time it takes for the logical device to accept the first user I/O on node B. “Time to performance” may be defined as the time it takes for the logical device to restore its original performance on node B.

There is a need for effective methods to reduce access latency and achieve high performance in a scale out storage system.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

Methods and apparatus for implementing a persistent read cache in a scale out storage system are disclosed to reduce access latency and achieve high performance. The persistent readcache addresses a number of limitations of prior art. Both cached data blocks in the persistent cache and distributed data placements are referenced by their unique content IDs and deduplicated, thereby increasing effective cache size and storage capacity. The persistent read cache is inherently coherent across multiple nodes without a distributed lock manager and stay valid across node reboots or crashes.

In accordance with some embodiments of the present disclosure, a method for caching data in a storage is provided. The method includes: storing metadata mapping logical addresses associated with logical data blocks of one or more logical devices to physical addresses of physical data blocks stored in a plurality of data storage devices of a storage system; creating distributed data placement based on the distributed hash table; creating one or more cached data blocks; and associating, by a processor, the cached data blocks with the content identifiers in the second metadata. The metadata includes: first metadata mapping the logical addresses associated with the logical data blocks of the logical devices to a plurality of content identifiers; a distributed hash table mapping the plurality of content identifiers to a plurality of node identifiers identifying a plurality of nodes of the storage system; and second metadata mapping the content identifiers to the physical addresses of the physical data blocks;

In some embodiments, the method further includes: deduplicating the cached data blocks across the logical devices on one of the plurality of nodes based on the content identifiers associated with the cached data blocks.

In some embodiments, the method further includes removing one or more of the cached data blocks to allocate more space for the distributed data placement.

In some embodiments, removing the one or more of the cached data blocks includes changing a flag in the second metadata indicative of whether a data block is a cached data block or a distributed data placement.

In some embodiments, the method further includes receiving, by a first processor on a first node of the plurality of nodes, a read request for a first logical block of a first logical device; determining, based on a first content identifier associated with the first logical block, whether there is a local copy of the first logical block; and reading, by the first processor, a physical data block based on the first content identifier in response to determining that there is a local copy of the first logical block.

In some embodiments, the method further includes in response to determining that there is no local copy of the first logical block, identifying a second node of the plurality of nodes using the distributed hash table; and sending, to a second processor on the second node, a request for reading the physical block.

In some embodiments, the method further includes in view of moving of an access point of a logical device from a third node to a fourth node of the plurality of nodes, identifying one or more cached data blocks on the third node that are associated with the logical device; and pushing one or more of the identified cached data blocks to the fourth node.

In some embodiments, pushing the one or more of the identified cached data blocks to the fourth node includes: selecting the one or more of the identified cached data blocks based on access frequency and recency; and pushing selected cached data blocks to the fourth node.

A system that implements the methods is provided. The system includes a memory; and a processor operatively coupled to the memory, the processor to: store metadata mapping logical addresses associated with logical data blocks of one or more logical devices to physical addresses of physical data blocks stored in a plurality of data storage devices of a storage system; create distributed data placement based on the distributed hash table; create one or more cached data blocks; and associate the cached data blocks with the content identifiers in the second metadata.

### BRIEF DESCRIPTION OF THE DRAWINGS

The present disclosure is illustrated by way of example, and not by way of limitation, in the figures of the accompanying drawings, in which:

FIG. 1 is a block diagram illustrating an example of a scale out storage system in accordance with an implementation of the disclosure;

FIG. 2 is a block diagram illustrating metadata stored in the scale out storage system in accordance with an implementation of the disclosure;

FIG. 3 is a block diagram illustrating a storage system implementing persistentead cache in accordance with an implementation of the disclosure;

FIG. 4 is a flow diagram illustrating a method of servicing a read request in accordance with an implementation of the disclosure;

FIGS. 5A, 5B, and 5C are block diagrams of illustrating mechanisms for implementing logical device mobility in accordance with an implementation of the disclosure;

FIG. 6 is a flow diagram illustrating a method of caching data blocks in accordance with the disclosure; and

FIG. 7 is a flow diagram illustrating an example of implementing logical device mobility utilizing cached data blocks in accordance with some embodiments of the disclosure.

### DETAILED DESCRIPTION

Providing low latency access and high performance for a scale out storage system is challenging as data blocks are distributed across multiple nodes and remote access incurs network latency. For example, in a 5-node scale out storage system that distributes data evenly across all the nodes, four out of five reads on a logical device may experience network latency. Some storage software implementations attempt to address this network latency issue by placing most or all of a logical device's data blocks on the node that provides the access point of the logical device (also known as data locality). However, such implementations may require distributing data placement based on logical device access points, which often results in unbalanced data distribution in terms of capacity and performance. In addition, when a logical device access point needs to be moved from node A to node B in support of logical device availability or mobility, most of the logical device's data blocks may have to be moved to node B as well, resulting in longer time to performance.

Some storage software implementations attempt to mitigate this network latency issue by employing a memory-based read cache. However, a memory-based read cache may require a large amount of expensive memory. Even at maximum capacity and pooled across all the nodes, a memory-based read cache is still too small for real world working sets. Memory-based read cache also cannot survive node crashes or node reboots, which may result in poor performance after a node failure or a node upgrade. Other storage software implementations employ persistent storage devices as part of their read cache to overcome the cost, capacity, and persistency limitations of a memory-based cache. These persistent read caches often require dedicated storage devices or dedicated partitions of storage devices, which may result in reduced storage capacity for user applications.

Maintaining cache coherence in a scale out storage system is also challenging. When more than one node in a scale out system stores cached copies of the same logical data block, problems may arise when the logical data block is changed on one node, leaving the other nodes with invalid cached copies. A distributed lock manager is often employed to achieve cache coherence in a scale out system by providing change notifications to all the nodes. However, the distributed lock manager may incur network latency itself and further compromises performance. Another example of cache coherence issue is crash recovery. After a node reboots or crashes, references to the cached copies on the node may have been invalidated by changes on the rest of the system during the node's down time. As a result, cached copies on the rebooted node will have to be discarded which results in poor performance after the node joins the system again.

To address the aforementioned and other deficiencies of existing solutions for providing scale out storage system, mechanisms (e.g., methods, systems, media, etc.) for implementing a persistent read cache in a scale out storage system are disclosed. The mechanisms may be implemented to reduce access latency and achieve high performance. In some embodiments, both cached data blocks in the persistent cache and distributed data placements are referenced by their unique content identifiers (Ms) and deduplicated, thereby increasing effective cache size and storage capacity.

The persistent read cache is inherently coherent across multiple nodes without relying on a distributed lock manager and stay valid across node reboots or crashes. It shares the same storage pool with distributed data placement without requiring separate partitions or dedicated storage devices. Data blocks are deduplicated before being stored in the persistent cache, so the effective cache size is significantly increased. Deduplication refers to elimination of duplicate or redundant information/data. For example, a first cached data block associated with a content ID may be regarded as being a duplicate of a second cached data block associated with the content ID. The first cached data block may be deleted to deduplicate data blocks associated with the content ID.

When capacity utilization is high cached data blocks in the persistent cache can be removed to gain tore space for distributed data placement. The less recently and frequently accessed cached data blocks can be removed first to minimize the impact on performance. In some implementations, when data blocks need to be redistributed to maintain redundancy and load balancing, a cached data block can become a distributed data placement or vice versa by changing a flag in the metadata without moving the physical data block.

Methods and apparatus for moving logical device access points in a scale out storage system are disclosed to reduce time to performance. After the access point of a logical device is moved from node A to node B, the more recently and frequently accessed cached copies for the logical device on node A is pushed to and cached on node B if these data blocks are not already stored on node B, reducing the amount of data movement and time to performance.

Of course, the present invention is not limited to the features, advantages, and contexts summarized above, and those familiar with storage technologies will recognize additional features and advantages upon reading the following detailed description and upon viewing the accompanying drawings.

For purposes of this disclosure, similar elements are identified by similar numeric reference numbers. A numeric reference number followed by a lowercase letter refers to a specific instance of the element.

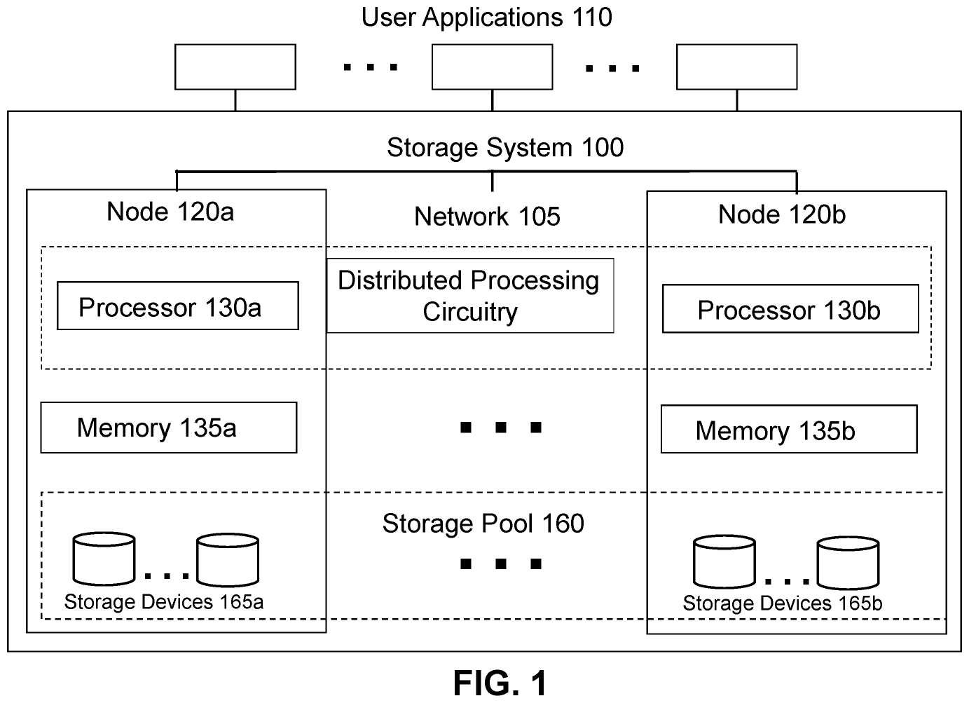

F FIG. 1 is a block diagram illustrating an example 100 of a scale out storage system 100 in accordance with some implementations of the present disclosure. The scale out storage system 100 may include one or more nodes 120 connected by a network 105. In an implementation, network 105 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long-Term Evolution (LTE) network), routers, hubs, switches, server computers, the like, and/or a combination thereof.

In some embodiments, a node 120 may include a processor 130, a memory 135, and one or more storage devices 165. The processor 130 may include a microprocessor, microcontroller, digital signal processor, hardware circuit, firmware, the like, or a combination thereof. The processors 130 at each node 120 may collectively form a distributed processing circuitry that may control the storage system. Memory 135 may include volatile and/or non-volatile memory for locally storing information and data used by the node. The storage devices 165 at different nodes 120 within the storage system 100 may collectively form a shared data storage pool 160. Examples of storage devices 165 include solid-state devices (SSDs), hard disk drives (HDDs), and a combination of SSDs and HDDs (Hybrid).

In some embodiments, the storage devices 165 may be configured under a RAID system for data redundancy and load balancing. Examples of the RAID system may include software RAID, hardware RAID card, RAID on a chip, Erasure Coding, or JBOD (Just a Bunch of Disks). The storage devices 165 may also include a non-volatile random-access memory (NVRAM) device for write caching and deferred writes. Examples of NVRAM devices include NVRAM cards, battery-backed dynamic random-access memory (DRAM), and non-volatile dual in-line memory module (NVDIMM). In some implementations, the storage devices 165 may be accessible by multiple nodes 120 or multiple storage systems 100 as shared storage devices.

The storage system 100 may provide logical device access to one or more user applications 110. In some implementations, the user application 110 and the storage system 100 may be running on the same physical systems. In other implementations the user application 110 may access the storage system 100 through a storage network such as Ethernet, FibreChannel, InfiniBand, and PCIe networks.

The processors 130 provide an interface between the user applications 110 and the storage devices 165. For example, the processors 130 may provide a set of commands for the application 110 to read from and write to the storage devices 165 in the storage pool 160. The processors 130 run storage software applications to provide storage virtualization, capacity reduction, scale out, availability, mobility, and performance that often cannot be achieved by the storage devices themselves.

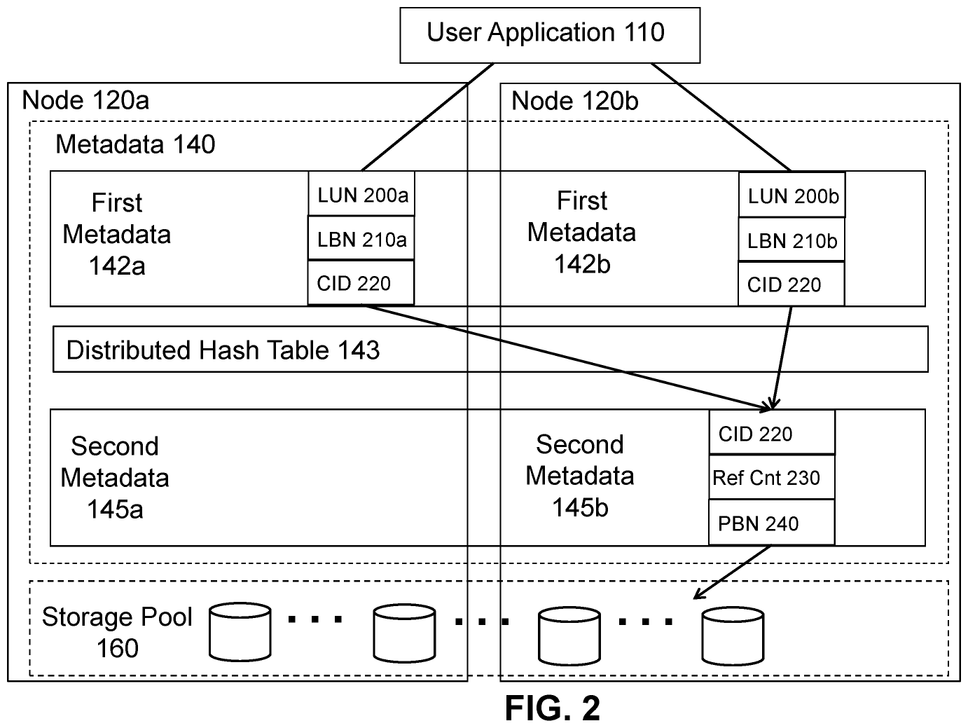

Metadata that may be used to manage various components of the storage system 100 may be stored on one or more nodes of the storage system 100. The metadata may map logical addresses associated with logical data blocks of logical devices of the storage system 100 to physical addresses of physical data blocks stored in the storage devices in the storage pool 160. For example, as shown in FIG. 2, metadata 140 may be stored, managed, processed, etc. on one or more nodes of storage system 100 (e.g., nodes 120a, 120b). The metadata 140 may include first metadata 142 (e.g., first metadata 142a, 142b), a distributed hash table (DHT) 143, and second metadata 145 (e.g., second metadata 145a, second metadata 145b). A logical data block is also referred to herein as a logical block. A physical data block is also referred to herein as a physical block.

The first metadata 142 may map the logical addresses associated with the logical data blocks of the logical devices to a plurality of content identifiers. Each of the content identifiers may identify the content of a logical data block. Multiple data block comprising the same content may be identified using the same content identifier. For example, the first metadata 142a on node 120a may map a first logical data block's LUN 200a and LBN 210a to a content ID (CID) 220. The content ID 220 may be a unique identifier identifying the content of the logical data block. The likelihood that two distinct blocks will have the same content ID is vanishingly small. In some embodiments, a second logical data block and the first logical data block may include the same content. In such embodiments, the second logical data block's LUN 200b and LBN 210b may be associated with the content ID 220. For example, the first metadata 142b on the node 120b may map LUN 200b and/or LBN 210b to the content ID 220.

In some implementations, a strong hash function, such as Secure Hash Algorithm 1 (SHA1) developed by the US National Institute for Standards and Technology (NIST), may be used to generate a content ID and make it computationally infeasible that two distinct blocks will have the same content ID. The first metadata entries may be stored in one or more metadata blocks. In some embodiments, a unique content ID may be generated for each of the metadata blocks.

The DHT 143 may be used to distribute data blocks and metadata blocks across the nodes 120 based on load balancing and/or data redundancy policies. Load balancing and data redundancy policies allow the distribution of data blocks while preventing network performance and availability issues. Network load balancing policies may provide for network redundancy and failover. DHT 143 may be used to provide a lookup service through which any participating node can retrieve the node IDs for any given content ID. In some implementations, responsibility for maintaining the mapping content IDs to node IDs may be distributed among the nodes 120 in such a way that a change in the set of participating nodes 120 causes a minimal amount of disruption. This may allow the distributed hash table 143 to scale to extremely large numbers of nodes and to handle continual node arrivals, departures, and failures. As used herein, “distributed data placement” may refer to data placement dictated by the distributed hash table 143. Distributed hash table 143 serves to achieve load balancing and data redundancy via distributed data placement, while persistent read cache is employed to reduce access latency and achieve higher performance.

The second metadata may map the content identifiers to the physical addresses of the physical data blocks of the storage devices. For example, as shown in FIG. 2, on node 120b the second metadata 145b may map the CID 220 to its physical location PBN 240 on the storage devices. In some embodiments in which the logical data block associated with LUN 200a/LBN 210a on node 120a and the logical data block associated with LUN 200b/LBN 210b on node 120b have duplicate contents, both logical data blocks may be associated with the same CID 220.

The distributed hash table 143 may map node ID 120b to CID 220. On node 120b in the second metadata 145b CID 220 is mapped to PBN 240. Therefore, two logical data blocks LUN 200a/LBN 210a on node 120a and LUN 200b/LBN 210b are deduplicated to one physical data block CID 220/PBN 240 on node 120b. As such, data deduplication is supported globally across all the LUNs 200 and all the nodes 120. A Reference Count 230 is maintained to reflect the number of LUN/LBN references CID 220 (the number of logical data blocks associated with CID 220). In some implementations, the processor 130 keeps track of the access frequency and recency of the physical data blocks CID 220/PBN 240 in the second metadata 145.

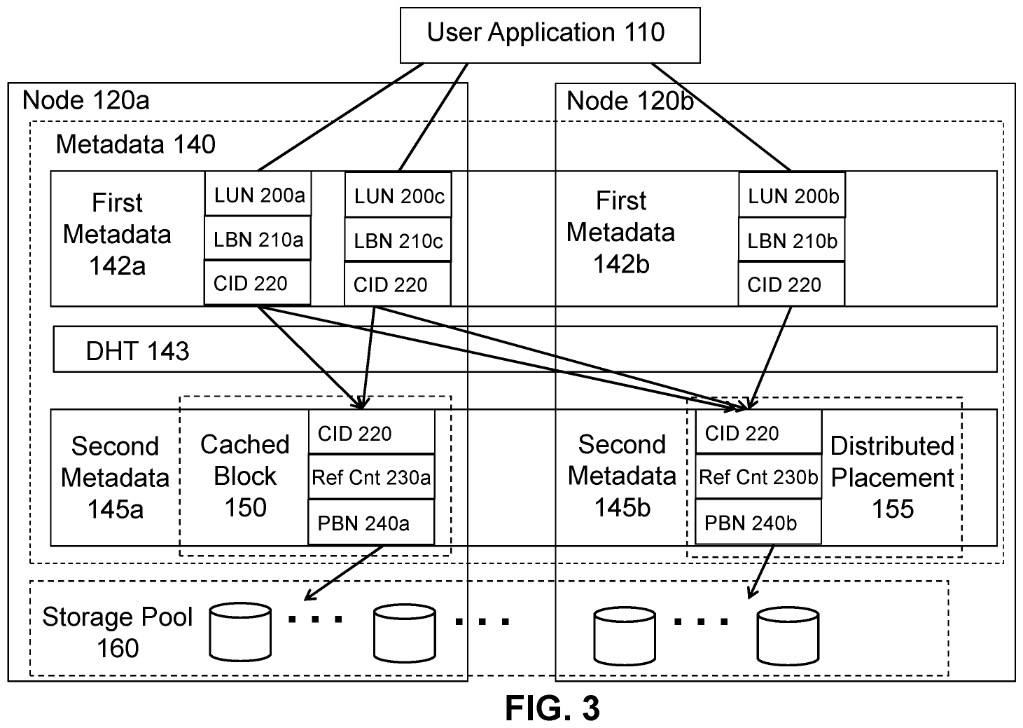

The present disclosure provides mechanisms for implementing the persistent read cache as illustrated in FIG. 3. An exemplary logical block LUN 200a/LBN210a on node 120a references a distributed data placement 155 on node 120b-CID 220/PBN 240b. A cached data block 150, CID 220/PBN 240a, is stored on node 120a, the same node as LUN 200a's access point, to reduce access latency. Both the cached data block 150 and the distributed data placement 155 are referenced by CID 220. A read request on logical block LUN 200a/LBN 210a can now be serviced by the cached data block 150 on node 120a without incurring the network latency associated with accessing the distributed data placement 155 on node 120b. The persistent cache not only reduces the access latency but also lessens the burden on the network 105 which results in higher overall system performance.

As shown in FIG. 3, when the logical block associated with LUN 200a/LBN 210a and the logical block associated with LUN 200c/LBN 210c on node 120a have identical content, the logical blocks are associated with the same content ID CID 220. Only one cached data block is stored on node 120a in associated with the content ID 220 (e.g., cashed block 150 associated with CID 220/PBN 240a). Cached data blocks may be deduplicated across all the logical devices on a storage node, thereby increasing the effective cache size. In an implementation, the cached data blocks are deduplicated across all logical devices on the same storage node.

Given that cached data blocks are stored on persistent storage devices instead of volatile memory, the persistent cache persists across node reboots or crashes. In the event node 120a reboots or crashes, once node 120a comes back online, the cached data block CID 220/PBN 240a is still available on storage devices 165a. Despite changes in the rest of the system during node 120a's downtime, logical data blocks LUN 200a/LBN210a and LUN 200c/LBN210c can still access the cached data block 150 by referencing content ID CID 220. In an implementation, the cached data blocks on any of the storage nodes are available and valid after the node crashes or reboots.

Because cached data blocks are referenced by their content IDs, cache coherence is inherently maintained without utilizing a distributed lock manager. In the event that the content of the exemplary logical block LUN 200a/LBN 210a is changed on node 120a, its content ID may be regenerated and it would no longer reference the cached data block CID 220/PBN 240a on node 120a or the distributed data placement CID 220/PBN 240b on node 120b. All other logical blocks that reference content ID CID 220, such as LUN 200b/LBN 210b on node 120b and LUN 200c/LBN 210c on node 120a may still access cached data block CID 220/PBN 240a and distributed placement CID 220/PBN 240b. Therefore, there is no need for change notification by a distributed lock manager. In an implementation, the cached data blocks are inherently coherent across all storage nodes without a distributed lock manager.

In some implementations, the cached data blocks 150 share the same storage pool 160 with the distributed data placement 155 without requiring separate partitions or dedicated storage devices. When the storage pool 160 is near its full capacity, some of the cached data blocks can be removed to gain more space for distributed data placement without compromising data redundancy. In some implementations, the less recently and frequently accessed cached data blocks can be removed first to minimize the impact on performance.

DHT 143 serves to achieve load balancing and data redundancy via distributed data placement, while persistent read cache is employed to reduce access latency. In some implementations, the processor 130 may maintain a flag in the second metadata 145 to indicate whether a physical data block is a cached data block or a distributed data placement. In a dynamic environment where data blocks are constantly redistributed to maintain load balancing and redundancy, a cached data block can become a distributed data placement or vice versa by changing the flag in the second metadata without moving the physical data block.

In some implementations, upon reading a cached data block or distributed data placement, the data block's content ID is recalculated and compared to the content ID in the second metadata to verify data integrity. For example, upon reading the cached data block at PBN 230a or the distributed data placement at PBN 230b, the storage processor 130a is configured to compute the physical block's content ID and compare it to CID 220 in the second metadata 142. If the two content IDs do not match, the processor 130a may detect that there is a data corruption and attempts to read instead from a redundant copy of CID 220.

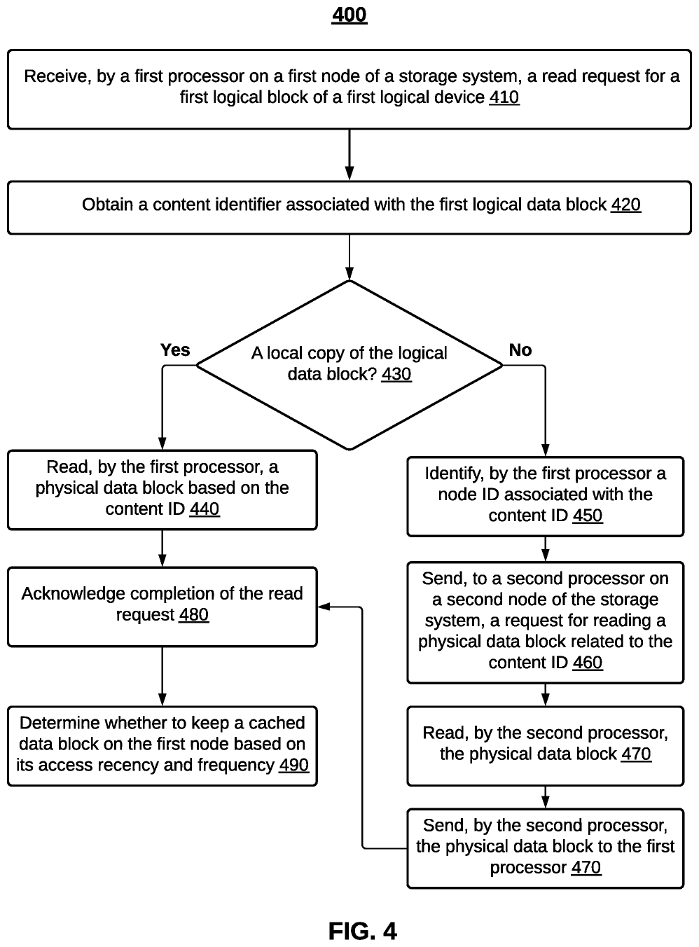

FIG. 4 is a flow diagram illustrating an example 400 of a method for servicing a read request originated from a user application in accordance with some implementations of the present disclosure.

Method 400 may start at block 410, where a first processor on a first node of a storage system may receive a read request for a first logical block of a first logical device. For example, as described in connection with FIG. 3, the processor 130a on the node 120a may receive a read request for the logical data block associated with LUN 200a/LBN 210a.

At step 420, the first processor may obtain a content identifier associated with the first logical data block. For example, the first processor may look up the content identifier in the first metadata that maps a plurality of content identifiers to a plurality of logical addresses of logical data blocks. Each of the logical addresses may include a LUN and/or LBN. As a more particular example, processor 130a may look up LUN 200a/LBN 210a in the first metadata 142a and obtain content ID CID 220.

At block 430, the first processor may determine whether there is a local copy of the logical data block. For example, the first processor may look up the content ID in the second metadata including one or more cashed blocks and/or distributed data placements on the first node. Each of the cashed blocks and/or the distributed data placements is associated with a content ID. The first processor may determine that there is a local copy of the logical data block in response to identifying a cashed block and/or distributed placement in the second metadata that is associated with the content ID.

In some embodiments, in response to determining that there is a local copy of the logical data block, method 400 may proceed to block 440. At block 440, the first processor may read a physical data block based on the content ID. For example, the first processor may identify a PBN associated with the content ID based on the second metadata (e.g., the cached block 150 of FIG. 3). The first processor may then read the physical data block that is associated with the PBN (e.g., PBN 250a of FIG. 3). The method may then proceed to 480.

In some embodiments, the first processor may proceed to block 450 in response to determining that there is no local copy of the logical data block (“NO” at block 430). At block 450, the first processor may identify a node ID associated with the content ID. For example, processor 130a may look up CID 220 in the DHT 143 and obtain node ID 120b that is associated with CID 220.

At block 460, the first processor may send, to a second processor on a second node of the storage system, a request for reading a physical data block related to the content D. The request may include, for example, the content ID, a request for looing up the content ID in the second metadata, etc. As an example, the processor 130a of FIG. 3 may request processor 130b to lookup CID 220 in the second metadata 145b and obtain CID 220/PBN 240b.

At block 470, the second processor may read the physical data block in response to receiving the request. For example, the second processor may look up the content ID in the second metadata to determine a PBN associated with the content D. As a more particular example, the processor 130b of FIG. 3 may read the physical block at PBN 240b. At block 475, the second processor may send the content of the physical data block to the first processor.

At block 480, the first processor may acknowledge completion of the read request to the application. At block 490, the first processor may determine whether to keep a cached data block on the first node based on its access recency and frequency. For example, the less recently and frequently accessed cached data blocks may be removed. Removing a cached data block may involve updating a flag in the second metadata that indicates whether a physical data block is a cached data block or a distributed data placement.

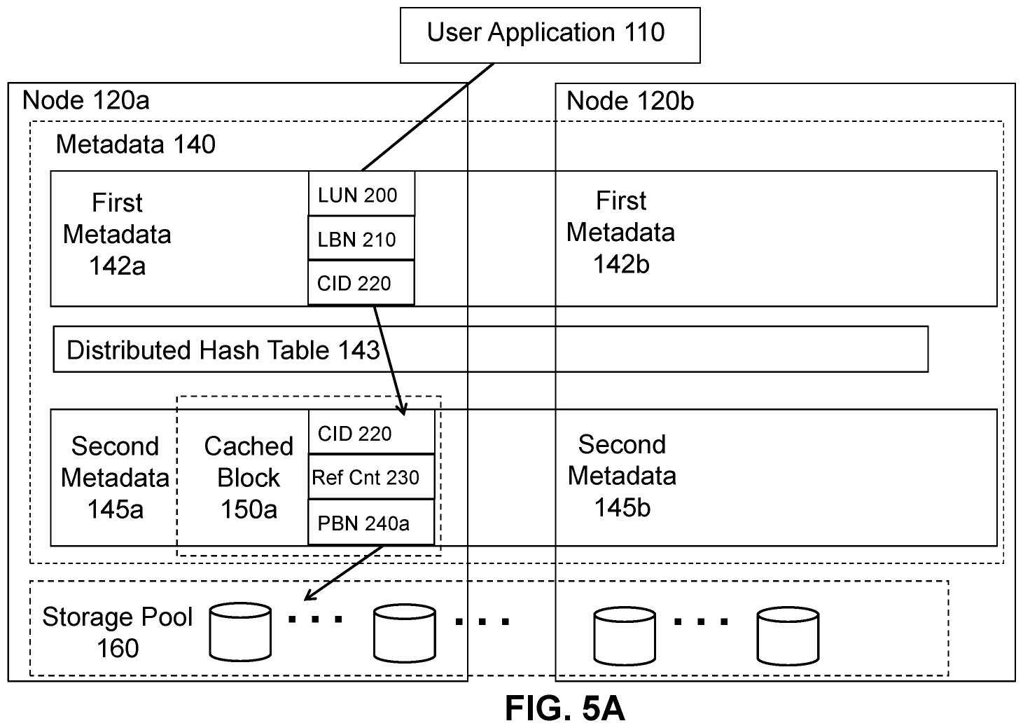

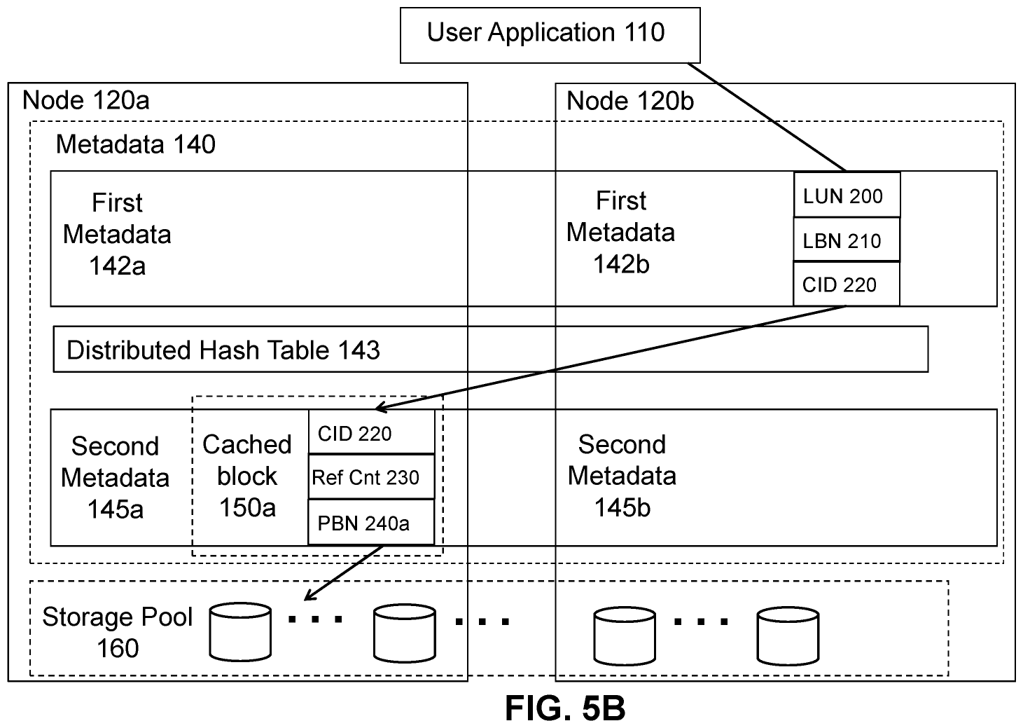

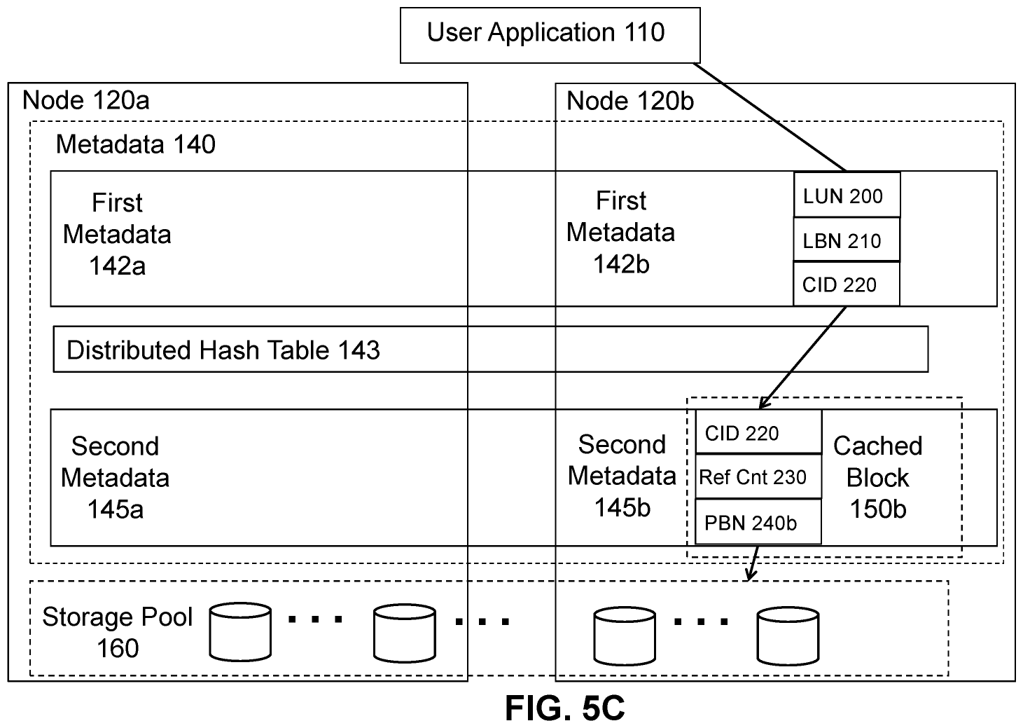

FIGS. 5A, 5B, and 5C are block diagrams illustrating mechanisms for logical device mobility in accordance with some embodiments of the present disclosure. As illustrated in FIG. 5A, an exemplary logical device LUN 200 has its access point on node 120a. The access point of LUN 200 is then moved from node 120a to node 120b. In some implementations where the metadata 140 is accessible by all nodes, the processor 130a may de-activate access to the logical device LUN 200 on node 120a and the processor 130b may activate access to the logical device LUN 200 on node 120b (FIG. 5B). Time to access is almost instantaneous without moving data or metadata. Read requests on the new access point of LUN 200 on node 120b may now experience a cache miss as there is no cached data block for LUN 200 on node 120b. LUN 200 on node 120b will not restore its original performance until all of its frequently and recently accessed data blocks are cached on node 120b. Time to performance is poor.

In some embodiments, after the exemplary logical device LUN 200 is moved from node 120a to node 120b, the processor 130a may identify all cached data blocks for LUN 200 on node 120a and may push the identified cached data blocks to node 120b. For example, as illustrated in FIG. 5C, a cached block 150b may correspond to cached block 150a of FIG. 3 pushed from node 120a to node 120b. Read requests on the new access point of LUN 200 on node 120b can now be serviced by reading the cached data block 150b on node 120b. Performance may be restored after a relatively shorter time to performance. Pushing a cached data block may involve copying and/or moving of data of the cached data block. In some implementations, the processor 130a may selectively push one or more of the identified cached data blocks for LUN 200 to further reduce the time to performance. For example, the processor 130a may push the more frequently and recently accessed cached data blocks first from node 120a to node 120b. The processor 130a may then push the remaining data blocks for LUN 200 to node 120b. In an implementation, the processor 130a may identifies all cached data blocks across the storage nodes for a logical device in a node and pushes the identified cached data blocks to the node as node that serves as an access point of the logical device.

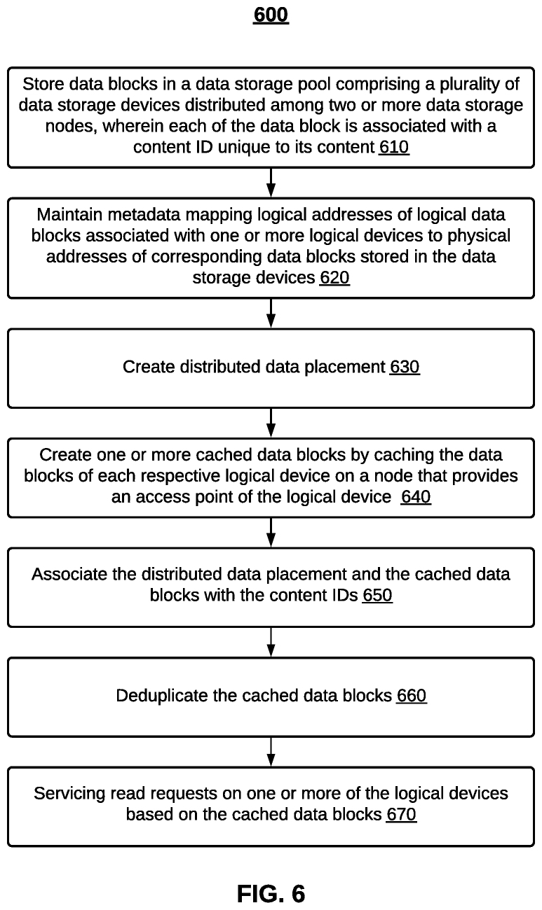

FIG. 6 is a flow diagram illustrating an example 600 of caching data blocks in accordance with some embodiments of the disclosure. Method 600 may be performed by one or more processor which may include hardware (e.g., circuitry, dedicated logic, programmable logic, microcode, etc.), software (e.g., instructions run on a processing device to perform hardware simulation), or a combination thereof.

Method 600 may begin at block 610, where data blocks are stored in a data storage pool comprising a plurality of data storage devices distributed among two or more data storage nodes. Each of the data blocks may be associated with a content ID unique to its content. For example, the data blocks are stored by processor 130 and/or storage system 100 in storage pool 160 in node 120b with CID 220.

At 620, metadata mapping logical addresses of logical data blocks associated with one or more logical devices to physical addresses of corresponding data blocks stored in the data storage devices are maintained. For example, the data block stored in the storage pool in node 120b is mapped to first metadata 142b with LUN 200b, LBN 210b, and CID 220. CID 220 is mapped to second metadata 145b with CID 220, Ref Cnt 230b, and PBN 240b. Processor 130 may maintain the metadata in DHT 143 or elsewhere.

The metadata may include first metadata mapping the logical addresses of the logical data blocks on the logical devices to a plurality of content IDs. Each of the logical data blocks may be mapped to a respective content ID. The metadata may further include distributed hash table mapping the content IDs to corresponding node IDs of the storage nodes where corresponding physical blocks are stored. The metadata may further include second metadata mapping the corresponding content IDs on each node to a plurality of physical addresses of the data blocks stored on the node. Each of the content IDs may be mapped to one or more of the physical addresses.

At 630, distributed data placements may be created. For example, a physical data block placement may be distributed across the storage nodes and the storage devices. More particularly, for example, processor 130 and/or storage system 100 may create distributed placement 155 across the nodes based on load balancing and data redundancy policies of DHT 143. In some embodiments, the physical data block placement may be distributed based on load balancing and data redundancy policies of the distributed hash table to create the distributed data placement).

At 640, one or more cached data blocks may be created by caching the data blocks for each of the logical devices on a node that provides an access point of the logical. For example, a first node of the storage system (e.g., node 120a) may provide the access point of the logical device associated with LUN 200a. Processor 130 and/or storage system 100 may generate the cached block 150 and data stored in storage pool 160 to node 120a.

At 650, the distributed data placement and the cached data blocks may be associated with their unique content IDs in the second metadata. Specifically, both cached block 150 in second metadata 145a and distributed placement 155 in second metadata 145b are referenced by content ID CID 220.

At 660, the cached data blocks may be deduplicated. For example, the processor may identify a plurality of cached data blocks on a given node (e.g., node 120a) that are associated with a given content ID (CID 220). The cached data blocks may be associated with one or more logical data blocks. The processor may then deduplicate the cached data blocks so that a predetermined number of copies of the cached data blocks on the given node are associated with the given content ID. In some embodiments, each content ID is associated with one cached data block on the given node.

At step 670, read requests are serviced on any of the logical devices by reading its cached data blocks without incurring network latency. For example, after the cached block 150 is created in node 120a, read request of the logical device LUN 200a in node 120a are serviced by reading cached block 150. The read request is serviced by storage system 100 without incurring latency of network 105. In some embodiments, servicing the read requests may involve performing one or more operations as described in connection with FIG. 4 above.

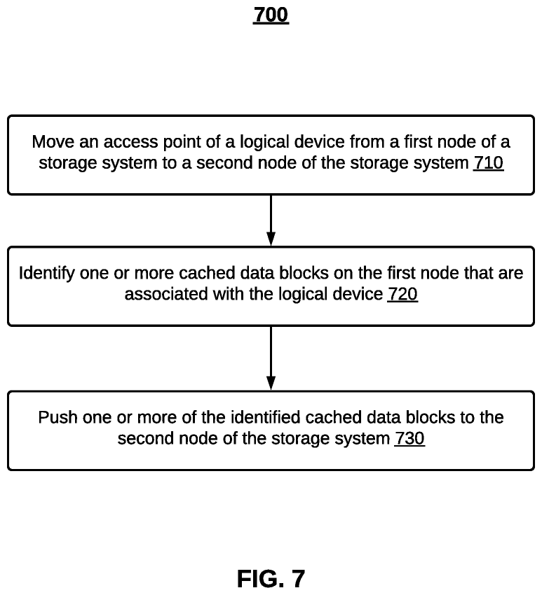

FIG. 7 is a flow diagram illustrating an example 700 of implementing logical device mobility utilizing cached data blocks in accordance with some embodiments of the disclosure. Method 700 may be performed by one or more processors which may include hardware (e.g., circuitry, dedicated logic, programmable logic, microcode, etc.), software (e.g., instructions run on a processing device to perform hardware simulation), or a combination thereof.

Method 700 may begin at block 710, an access point of a logical device may be moved from a first node of a storage system to a second node of the storage system. For example, as described in connection with FIGS. 5A-5B, the logical device associated with LUN 200 may be moved from node 120a to 120b.

At block 720, a processor may identify one or more cached data blocks on the first node that are associated with the logical device. For example, the logical device may include one or more logical data blocks. The processor may identify a content ID for each of the logical data block (e.g., by looking up the logical address associated with the logical device). The processor may then identify the one or more cached data blocks based on the content ID. For example, the processor may look up the content ID in the second metadata stored on the first node to identify the cached block(s) associated with the content ID. The first metadata may include a data entry mapping a logical address of a first logical data block of the logical device to a first content ID (e.g., first metadata 142a of FIGS. 5A-5B that maps LUN 200/LBN 210 to CID 220). The second metadata stored on the first node may include a cached block that maps the first content ID to a physical address of a physical data block of the storage system (e.g., cached block 150a of FIGS. 5A-5B).

At block 730, the processor may push one or more of the identified cached data blocks to the second node of the storage system. Pushing a cached data block from the first node to the second node may involve coping the data of the cached data block and storing the data of the cached block on the second node. In some embodiments, the processor may push each of the identified cached data blocks to the second node. In some embodiments, the cached data blocks may be pushed to the second node in an order determined based on frequency and/or recency of access to each of the data blocks by one or more user applications. For example, the processor may select one or more of the identified data blocks based on the frequency and/or recency of access to each of the identified data blocks by one or more user applications (e.g., by selecting one or more data blocks that are most frequently and/or recently accessed by the user applications). The processor may push the selected data blocks to the second node. In some embodiments, the processor may then push the remaining data blocks associated with the logical device to the second node after pushing the selected data blocks to the second node. As a more particular example, as described in connection with FIGS. 5A-5C, cached block 150a may be pushed from node 120a to 120b by creating cached block 150b on node 120b.

In the foregoing description, numerous details are set forth. It may be apparent, however, that the disclosure may be practiced without these specific details. In some instances, well-known structures and devices are shown in block diagram form, rather than in detail, in order to avoid obscuring the disclosure.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “receiving,” “moving,” “generating,” “determining,” “sending,” “referencing,” “storing,” “updating,” “pushing,” “identifying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a machine-readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems may appear as set forth in the description below. In addition, the disclosure is not described with reference to any particular programming language. It may be appreciated that a variety of programming languages may be used to implement the teachings of the disclosure as described herein.

The disclosure may be provided as a computer program product, or software, that may include a machine-readable storage medium having stored thereon instructions, which may be used to program a computer system (or other electronic devices) to perform a process according to the disclosure. A machine-readable storage medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), etc.

For purposes of this disclosure, any element mentioned in the singular form can also include the plural and vice-versa.

Although some figures depict lines with arrows to represent intra-network or inter-network communication, in other implementations, additional arrows may be included to represent communication. Therefore, the arrows depicted by the figures do not limit the disclosure to one-directional or bi-directional communication.

Whereas many alterations and modifications of the disclosure may no doubt become apparent to a person of ordinary skill in the art after having read the foregoing description, it is to be understood that any particular example shown and described by way of illustration is in no way intended to be considered limiting. Therefore, references to details of various examples are not intended to limit the scope of the claims, which in themselves recite only those features regarded as the disclosure.

What is claimed is:

1. A method, comprising:
storing metadata mapping logical addresses associated with logical data blocks of one or more logical devices to physical addresses of physical data blocks stored in a plurality of data storage devices of a storage system, the metadata comprising:
first metadata mapping the logical addresses associated with the logical data blocks of the logical devices to a plurality of content identifiers;
a distributed hash table mapping the plurality of content identifiers to a plurality of node identifiers identifying a plurality of nodes of the storage system; and
second metadata mapping the content identifiers to the physical addresses of the physical data blocks;
creating distributed data placement based on the distributed hash table;
creating one or more cached data blocks, comprising:
caching the logical data blocks of each of the logical device on a node that provides an access point of the logical device; and
associating, by a processor, the cached data blocks with the content identifiers in the second metadata.

2. The method of claim 1, further comprising:
deduplicating the cached data blocks across the logical devices on one of the plurality of nodes based on the content identifiers associated with the cached data blocks.

3. The method of claim 1, further comprising:
removing one or more of the cached data blocks to allocate more space for the distributed data placement.

4. The method of claim 3, wherein removing the one or more of the cached data blocks comprises:
changing a flag in the second metadata indicative of whether a data block is a cached data block or a distributed data placement.

5. The method of claim 1, further comprising:
receiving, by a first processor on a first node of the plurality of nodes, a read request for a first logical block of a first logical device;
determining, based on a first content identifier associated with the first logical block, whether there is a local copy of the first logical block; and
reading, by the first processor, a physical data block based on the first content identifier in response to determining that there is a local copy of the first logical block.

6. The method of claim 5, further comprising:
in response to determining that there is no local copy of the first logical block, identifying a second node of the plurality of nodes using the distributed hash table; and
sending, to a second processor on the second node, a request for reading the physical data block.

7. The method of claim 1, further comprising:
in view of migration of an access point of a logical device from a third node to a fourth node of the plurality of nodes, identifying one or more cached data blocks on the third node that are associated with the logical device; and
pushing one or more of the identified cached data blocks to the fourth node.

8. The method of claim 7, wherein pushing the one or more of the identified cached data blocks to the fourth node comprises:
selecting the one or more of the identified cached data blocks based on access frequency and recency; and
pushing selected cached data blocks to the fourth node.

9. A system, comprising:
a memory; and
a processor operatively coupled to the memory, the processor to:
store metadata mapping logical addresses associated with logical data blocks of one or more logical devices to physical addresses of physical data blocks stored in a plurality of data storage devices of a storage system, the metadata comprising:
first metadata mapping the logical addresses associated with the logical data blocks of the logical devices to a plurality of content identifiers;
a distributed hash table mapping the plurality of content identifiers to a plurality of node identifiers identifying a plurality of nodes of the storage system; and
second metadata mapping the content identifiers to the physical addresses of the physical data blocks
create distributed data placement based on the distributed hash table;
create one or more cached data blocks by caching the data blocks of each of the logical device on a node that provides an access point of the logical device; and
associate, by the processor, the cached data blocks with the content identifiers in the second metadata.

10. The system of claim 9, wherein the processor is further to:
deduplicate the cached data blocks across the logical devices on one of the plurality of nodes based on the content identifiers associated with the cached data blocks.

11. The system of claim 9, wherein the processor is further to:
remove one or more of the cached data blocks to allocate more space for the distributed data placement.

12. The system of claim 11, wherein, to remove the one or more of the cached data blocks, the processor is further to:
change a flag in the second metadata indicative of whether a data block is a cached data block or a distributed data placement.

13. The system of claim 9, wherein the processor is further to:
receive a read request for a first logical block of a first logical device;
determine, based on a first content identifier associated with the first logical block, whether there is a local copy of the first logical block; and
read a physical data block based on the first content identifier in response to determining that there is a local copy of the first logical block.

14. The system of claim 13, wherein the processor is further to:
in response to determining that there is no local copy of the first logical block, identify a second node of the plurality of nodes using the distributed hash table; and
send, to a processor on the second node, a request for reading the physical block.

15. The system of claim 9, wherein the processor is further to:
in view of moving of an access point of a logical device from a third node to a fourth node of the plurality of nodes, identify one or more cached data blocks on the third node that are associated with the logical device; and
push one or more of the identified cached data blocks to the fourth node.

16. The system of claim 15, wherein, to push the one or more of the identified cached data blocks to the fourth node, the processor is further to:
select the one or more of the identified cached data blocks based on access frequency and recency; and
push selected cached data blocks to the fourth node.

17. A non-transitory machine-readable storage medium including instructions that, when accessed by a processor, cause the processor to:
store metadata mapping logical addresses associated with logical data blocks of one or more logical devices to physical addresses of physical data blocks stored in a plurality of data storage devices of a storage system, the metadata comprising:
first metadata mapping the logical addresses associated with the logical data blocks of the logical devices to a plurality of content identifiers;
a distributed hash table mapping the plurality of content identifiers to a plurality of node identifiers identifying a plurality of nodes of the storage system; and
second metadata mapping the content identifiers to the physical addresses of the physical data blocks
create distributed data placement based on the distributed hash table;
create one or more cached data blocks by caching the data blocks of each of the logical device on a node that provides an access point of the logical device; and
associate, by the processor, the cached data blocks with the content identifiers in the second metadata.

18. The non-transitory machine-readable storage medium of claim 17, wherein the processor is further to:
deduplicate the cached data blocks across the logical devices on one of the plurality of nodes based on the content identifiers associated with the cached data blocks.

19. The non-transitory machine-readable storage medium of claim 18, wherein the processor is further to:
remove one or more of the cached data blocks to allocate more space for the distributed data placement.

20. The non-transitory machine-readable storage medium of claim 17, wherein the processor is further to:
receive a read request for a first logical block of a first logical device;
determine, based on a first content identifier associated with the first logical block, whether there is a local copy of the first logical block; and
read a physical data block based on the first content identifier in response to determining that there is a local copy of the first logical block.
